(19) United States
(12) Patent Application Publication
(10) Pub. No.: US 2015/0217485 A1
(43) Pub. Date: Aug. 6, 2015

(54) DEVICE FOR INFUSING A COMPOSITE PART AND ASSOCIATED METHOD

(71) Applicant: EUROPEAN AERONAUTIC DEFENCE AND SPACE COMPANY EADS FRANCE, Paris (FR)

(72) Inventor: Stephane Aufray, Saint Lyphard (FR)

(21) Appl. No.: 14/427,971

(22) PCT Filed: Sep. 12, 2013
(86) PCT No.: PCT/EP2013/068942

§ 371 Date: Mar. 12, 2015

(30) Foreign Application Priority Data
Sep. 17, 2012 (FR) 1258703

(51) Int. Cl. B29C 35/02

(52) U.S. Cl. CPC B29C 35/0261; B29L 2009/00

(57) ABSTRACT

A device for infusing a resin into a fibrous perform. The device includes a mold having a sealed cavity configured to receive the fibrous perform and a liquid resin intake, and a caul plate arranged inside the cavity in contact with the fibrous perform. The device includes a measurement apparatus having a transmitter and a receiver configured to transmit and receive an ultrasonic signal via a section of the fibrous perform. The reception of the ultrasonic signal being carried out via the caul plate.

### TECHNICAL FIELD OF THE INVENTION

The invention relates to a device for infusing a composite part and the associated method.

This invention is applicable to the field of resin infusion processes for manufacturing a composite part from a dry fibrous preform. More particularly, the device and the method that are the subject of the invention concern nondestructive inspection and control in liquid resin infusion (LRI) processes.

### PRIOR ART

The manufacture of a composite part using an LRI process comprises two main steps: producing a dry fibrous preform then injecting a resin into the fibrous preform.

This manufacturing process allows a structure of complex shape to be produced, simplifying the assembly step and preventing the need for (bolted or adhesive) joints that would weaken the part.

The liquid resin infusion process described in document FR 2 948 600 is a process for manufacturing a composite part, employing a low-pressure vacuum to transfer resin into a dry fibrous preform. The preform, consisting of layers of fibrous plies, is placed in the sealed cavity of a mold between a bleeder fabric and a perforated caul plate. Since the cavity is under vacuum, liquid resin is transferred into the thickness of the preform in a direction substantially normal to the layers. The bleeder fabric, placed on the side on which the resin is injected, spreads the propagation front of the liquid resin over the entire area of the preform. The caul plate calibrates the thickness of the part. Thus, the liquid resin propagates into the thickness of the fibrous preform as far as the caul plate. According to the prior art, this caul plate is provided with heating means that, by heating the preform, ensure the resin remains fluid.

The end of injection is detected by overflow of the resin through the perforations in the caul plate. However, this visual effect does not make it possible to guarantee the absence of dry zones in the part thus obtained. This visual examination is combined with inspection of the volume of resin injected and the balance of internal pressures. These two parameters are difficult to control as calculation of the volume to be injected does not take into account the volume lost in the supply channels or excess resin lost after the last peel ply and spread by the caul plate. In addition, the calculation of the balance of internal pressures does not take into account possible movement of the bagging materials. The latter parameter modifies the resin volume content and therefore the thickness of the injected structure. This leads to the targeted fiber volume content, responsible for the objective mechanical behavior of the part, not being obtained.

Thus, to control the quality of a composite part produced using this manufacturing process, the method used in the prior art consists in destructive testing, samples being removed in order to allow the internal structure or strength properties of the part thus sampled to be analyzed. This method of analyzing the material health of produced parts does not make it possible to guarantee the parts will be 100% reliable and it is not suitable for analysis of small batches. In addition, this method increases the operating cost of the manufacturing process.

### OBJECT OF THE INVENTION

The aim of the invention is to remedy these drawbacks.

For this purpose, according to a first aspect, the invention relates to a device for infusing resin into a fibrous preform, said device comprising a mold, containing a sealed cavity able to receive the fibrous preform and containing an inlet for liquid resin, and a caul plate placed in the cavity and making contact with the fibrous preform, said device comprising a measuring means comprising an emitter and a receiver that are able to emit and receive an ultrasonic signal through a section of said fibrous preform, said signal being received through the caul plate.

The invention allows the material health of the composite part to be analyzed during the transfer of resin into the preform. The material health of the part is analyzable without destruction thereof. The invention thus improves the quality of the composite parts produced and simplifies the inspection thereof.

Advantageously, the measuring means comprises an emitter/receiver sensor and the caul plate comprises a void in which it is possible to position said sensor. An emitter/receiver sensor is particularly suitable for thin composite parts. In addition, installation of such a sensor in the infusing device is quite simple since all that this requires is for the caul plate to be drilled once.

Advantageously, the measuring means comprises an emitter positioned in a void in the mold and a receiver positioned in a void in the caul plate. Positioning the emitter and the receiver on either side of the fibrous preform makes it possible to limit the distance traveled by the ultrasound signal. This embodiment is particularly suitable for thick composite parts. In addition, separation of the emitter and receiver allows the emitter to be modified depending on the thickness of the composite part without changing both portions of the measuring means.

Advantageously, the device comprises an array of measuring means, said receivers of said measuring means of the array being distributed in regularly spaced rows and columns. This embodiment makes it possible to analyze the material health of a plurality of portions of a composite part simultaneously.

Advantageously, the caul plate is heated and the portion of the measuring means placed on said caul plate comprises a piezoelectric chip mounted on a substrate the material of which is able to withstand the heating temperature of the caul plate. This embodiment makes it possible to match the measuring means to the application. For example, a substrate made of graphite is particularly able to withstand thermoplastic injection at 390° C. whereas a substrate made of polyetheretherketone is particularly able to withstand injection of the epoxy resin at 180° C.

According to a second aspect, the invention relates to a method for infusing resin into a fibrous preform using a device according to the invention, the method comprising steps consisting in gradually saturating the fibrous preform with the liquid resin, emitting and receiving an ultrasonic signal through the fibrous preform, measuring the time taken for the ultrasonic signal to make a round trip in the section of the fibrous preform, and determining the degree of cure of the composite part depending on variations in this propagation time.

Propagation time is representative of a speed of propagation of the ultrasound signal in the composite part, which speed varies during the injection and infusion of the liquid resin. This method therefore allows variations in the density of the material of the composite part to be detected since the denser the composite the longer the propagation time. For example, for a composite part made of carbon epoxy, the propagation speed of the ultrasound signal is 2 mm/s before infusion, and 3 mm/s after infusion and polymerization. Estimating the degree of cure allows the mechanical strength of said composite part to be evaluated.

Advantageously, the method comprises steps consisting in measuring the relative amplitude of the ultrasonic signal, corresponding to the ratio of the amplitude of the emitted ultrasound signal to the amplitude of the received ultrasound signal, and determining the degree of cure of the composite part depending on the relative amplitude. The relative amplitude of the ultrasound signal makes it possible to discern the density of the material of the composite part since the denser the part the less the ultrasound signal is attenuated. This embodiment thus enables a complementary analysis with propagation time.

Advantageously, the method comprises steps consisting in estimating a degree of saturation of the fibrous preform, depending on the propagation time and/or the relative amplitude of the received signal, and stopping the saturation of the fibrous preform when the fibrous preform has reached a maximum saturation threshold.

This embodiment allows the process of impregnating the fibrous preform with liquid resin to be controlled. It makes it possible to mitigate possible bagging-material movements, which for example occur when fluid is lost in the injection means. It thus makes it possible to avoid injecting too much or too little liquid resin into the preform, which was possible with prior art methods of estimating the degree of impregnation of the preform.

Advantageously, the method comprises the step of detecting a release film of the fibrous preform depending on the propagation time or the relative amplitude of the received signal. This embodiment allows the process for manufacturing composite parts of draped structure to be controlled and, for example the presence of foreign bodies such as polyethylene release films to be detected. The measuring means thus also plays a role as a detector.

### BRIEF DESCRIPTION OF THE FIGURES

Preferred but nonlimiting embodiments of the invention are described below with reference to FIGS. 1 to 7, in which:

FIG. 1 shows a cross-sectional view of an infusing device according to a first embodiment of the invention;

FIG. 2 shows a bottom view of a caul plate of the device in FIG. 1;

FIG. 3 shows a top view of the caul plate of the device in FIG. 1;

FIG. 4 shows a schematic diagram of the acquisition principle of an ultrasound measurement according to a second embodiment of the invention;

FIG. 5 shows a temporal measurement of the saturation and infusion of a fibrous preform;

FIG. 6 shows a temporal measurement of the infusion of a fibrous preform and the associated signal amplitude; and

FIG. 7 shows a bottom view of the caul plate of an infusing device comprising multiple sensors according to a third embodiment of the invention.

### DESCRIPTION OF PREFERRED EMBODIMENT OF THE INVENTION

In the description identical, similar or analogous elements have been given the same reference in all the figures.

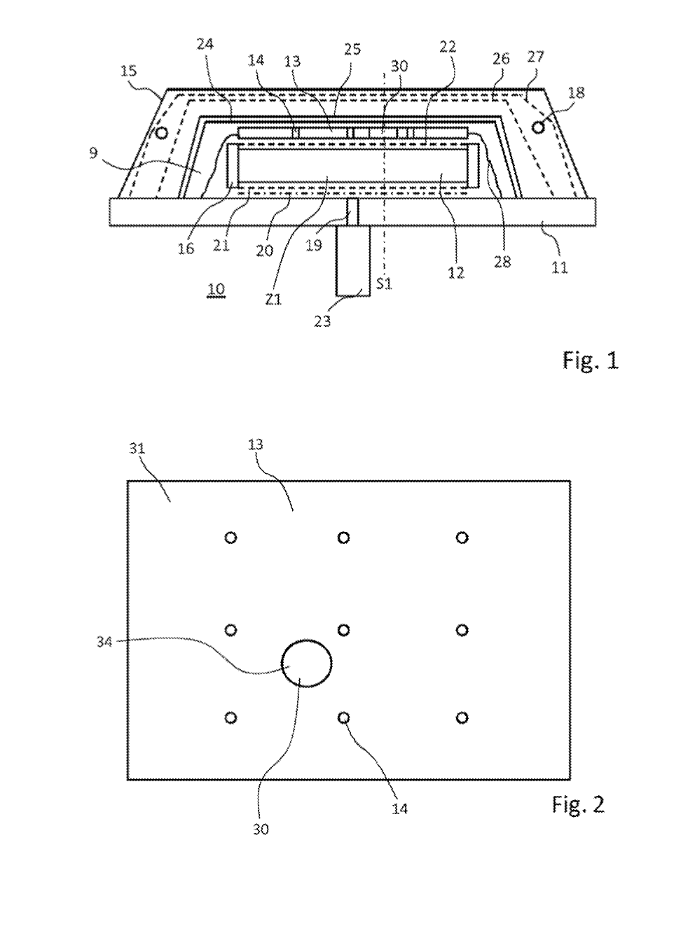

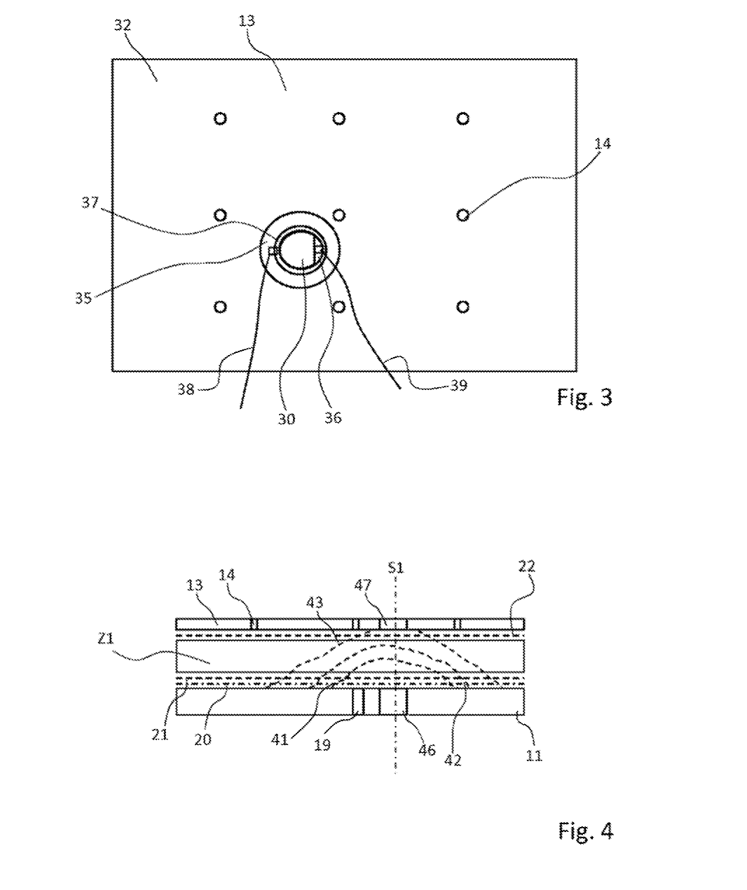

FIGS. 1 to 3 show a device 10 for infusing a composite part according to a first embodiment of the invention. The device 10 allows a liquid resin to be infused into a fibrous preform 12 comprising the matrix of the composite part to be produced.

The preform 12 is positioned on a mold 11 and covered with a sealed bladder 15 forming a cavity 9. More precisely, the preform 12 is positioned making longitudinal contact with the mold 11. The preform 12 is surrounded with a first peel ply 21 placed under and a second peel ply 22 placed on top, said plies being fastened to the sides of the preform 12 by a fastening means 16. The peel plies 21, 22 are preferably made of a Teflon-coated glass cloth, in order to make demolding the composite part easier. A bleeder material 20 is placed between the first peel ply 21 and the mold 11 so as to spread, over the preform 12, liquid resin injected from an injecting means 23 through a resin inlet 19 of the mold 11.

Calibration of the thickness of the preform 12 is ensured by a caul plate 13 placed above the preform 12. When the preform 12 is flat, the caul plate 13 may also adjust the planarity of the preform 12. The caul plate 12 comprises perforations 14 intended to remove surplus resin. When the caul plate 13 is heated, said caul plate 13 is connected to a control system by a set of connectors 28.

The caul plate 13 comprises a measuring means 30 able to emit and receive an ultrasound signal through a section S1 of the composite part. The measuring means 30 comprises a piezoelectric chip 36 equipped with a flat head 34 the surface of which is positioned in the same plane as the bottom surface 31 of the caul plate 13. The chip 36 is mounted on a circular substrate 35 positioned on the top surface 32 of the caul plate 13. The substrate 35 is preferably matched to the operating temperature of the caul plate 13. A seal 37 is positioned around the chip 36 in order to prevent resin loss. Data and supply signals are connected to the measuring means 30 by two wires 38, 39 laid over the top 32 of the caul plate 13.

All the elements, from the caul plate 13 to the mold 11, are protected by two membranes 24, 25 and two bleeder cloths 26, 27 between which the cavity 9 comprises a vacuum pumping means 18.

FIG. 4 shows a second embodiment of the invention in which the measuring means 30 is divided into an emitting module 46 placed in the mold 11, and a receiving module 47 placed in the caul plate 13. The ultrasound signal passes once through the section 51 of the preform 12 instead of making a round trip (case of the first embodiment).

In the section 51, a first resin front 41 represents an instant at the start of infusion of the preform 12. A second resin front 42 represents an instant of partial saturation of the preform 12, and a third resin front represents an instant of complete saturation of the preform 12.

The injection process consists in heating the resin and the preform 12 then in injecting resin into the preform 12. The resin rapidly flows firstly into the bleeder material 20 then it diffuses through the peel ply 21 before infiltrating the preform 12 as far as the caul plate 13. The perforations 14 in the latter remove excess resin.

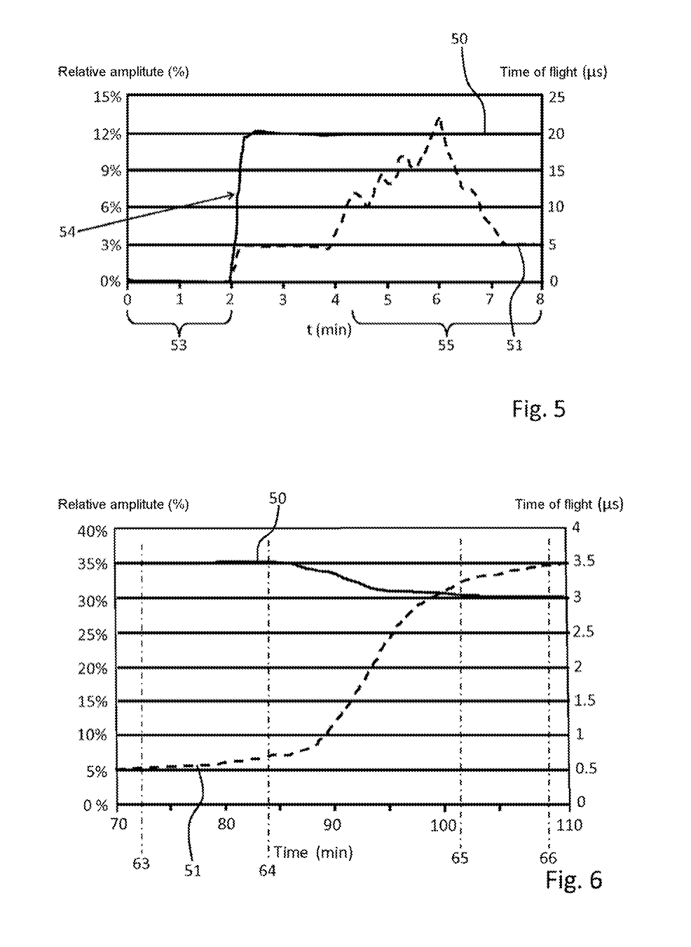

In the injection and infusion process, the measuring means 30 allow the propagation time 50 of the ultrasonic signal, i.e. the time required for said signal to pass through a section S1 of the preform, to be measured. The measuring means 30 allows a relative amplitude 51 between the amplitude of the emitted ultrasound signal and the amplitude of the received ultrasound signal to be estimated. FIGS. 5 and 6 show plots of the propagation time 50 and relative amplitude 51 as a function of time. In a first period 53, extending from 0 to 2 minutes, the liquid resin has not yet made contact with the sensor 47. After 2 minutes, the liquid resin makes contact with the sensor 47 and the preform is rapidly saturated with resin. This impregnation effect 54 leads to a large increase in the propagation time 50, between 0 and 20 μs, and to an increase in the relative altitude 51, between 0 and 3%. The appearance of this impregnation effect 54 makes it possible to stop saturation of the preform 12 and to control the quality of the injection process. As a variant, this impregnation effect 54 also allows a release film of the preform 12 to be detected.

When the preform 12 is saturated with resin, the resin starts to set under the effect of the temperature and to cure to form the structure of the final composite part. In the intermediate phase 55 of the start of the infusion, the propagation time 50 is substantially constant and the relative amplitude 51 varies greatly depending on the structure of the fibrous preform 12. FIG. 6 shows how this curing effect varies during the polymerization cycle, i.e. between 70 and 110 minutes. This figure shows that propagation time 50 decreases during the infusion whereas relative amplitude 51 increases.

At the instant 63, substantially equal to 72 min, the temperature of the device is increased in order to activate the reaction. Propagation time 50 is substantially constant at 3.5 μs and relative amplitude 51 is substantially constant at 5%.

At the instant 64, substantially equal to 84 min, the device reaches the gel point marking the start of the curing. Between the instants 63 and 64, relative amplitude 51 increases slightly and propagation time 50 decreases slightly.

At the instant 65, substantially equal to 101 min, the device reaches the solidification point. Between the instants 64 and 65, the relative amplitude 51 greatly increases and the propagation time 50 greatly decreases.

At the instant 66, the device is in a finishing phase of the solidification. Between the instants 66 and 65, the relative amplitude 51 slightly increases to tend toward 35% and the propagation time 50 slightly decreases to tend toward 3 μs.

During the polymerization cycle, the variations in relative amplitude 51 or propagation time 50 make it possible to study the material health of the composite part. Specifically, if the preform 12 comprises a foreign body (release film, transfer paper, etc.) during the polymerization, the ultrasound signal strikes this foreign body during the transmission of the ultrasound signal and this impacts relative amplitude 51 and/or propagation time 50 depending on the nature and position of the foreign body. In practice, the relative amplitude 51 of a composite part comprising a foreign body will be smaller than the relative amplitude 51 expected for the same part.

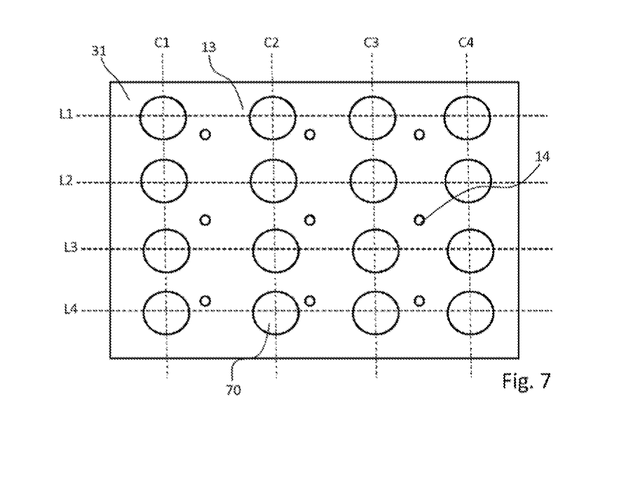

FIG. 7 shows a third embodiment in which the caul plate 13 comprises an array 70 of measuring means 30 regularly distributed in four rows L1-L4 and four columns C1-C4. This embodiment allows the infusing device to provide an analysis of material health in a plurality of different locations on the composite part.

1-10. (canceled)

11. A device for infusing resin into a fibrous preform, comprising:
a mold comprising a sealed cavity configured to receive the fibrous preform and an inlet for a liquid resin;
a caul plate placed in the sealed cavity in contact with the fibrous perform; and
a measuring apparatus comprising an emitter and a receiver configured to emit and receive an ultrasonic signal through a section of the fibrous preform, the ultrasonic signal being received through the caul plate.

12. The device as claimed in claim 11, wherein the measuring apparatus comprises an emitter/receiver sensor positioned in a void of the caul plate.

13. The device as claimed in claim 11, wherein the emitter is positioned in a void in the mold and the receiver is positioned in a void in the caul plate.

14. The device as claimed in claim 11, further comprising an array of measuring apparatus, the receivers of the array of the measuring apparatus being distributed in regularly spaced rows and columns.

15. The device as claimed in claim 11, wherein the caul plate is heated; and wherein a portion of the measuring apparatus placed on the caul plate comprises a piezoelectric chip mounted on a substrate of a material capable of withstanding a heating temperature of the caul plate.

16. The device as claimed in claim 15, wherein the substrate is made of graphite.

17. A method for infusing resin into a fibrous perform using an infusing device, the method comprising the steps of:
gradually saturating the fibrous preform in a sealed cavity of a mold of the infusing device with a liquid resin through an inlet of the mold, a caul plate of the infusing device is placed in the sealed cavity of the mold in contact with the fibrous perform;
emitting and receiving an ultrasonic signal through the fibrous perform respectively by an emitter and a receiver of a measuring apparatus;
measuring a propagation time for the ultrasonic signal to complete a round trip in a section of the fibrous preform by the measuring apparatus, the ultrasonic signal being received through the caul plate; and
determining a degree of cure of a composite part depending on variations of the propagation time.

18. The method as claimed in claim 17, further comprising the steps of:
measuring a relative amplitude of the ultrasonic signal corresponding to a ratio of an amplitude of the emitted ultrasound signal to an amplitude of the received ultrasound signal; and
determining the degree of cure of the composite part depending on the relative amplitude.

19. The method as claimed in claim 18, further comprising the steps of:
estimating a degree of saturation of the fibrous preform depending on at least one of the propagation time or the relative amplitude of the received signal; and
stopping saturation of the fibrous preform based on a determination that the fibrous preform has reached a preset saturation threshold.

20. The method as claimed in claim 18, further comprising the step of detecting a release film of the fibrous preform depending on at least one of the propagation time or the relative amplitude of the received signal.
